(19) United States
(12) Patent Application Publication
(10) Pub. No.: US 2004/0204824 A1
(43) Pub. Date: Oct. 14, 2004

(54) Navigation device and communication method

(75) Inventors: Mitsuhiro Naito, Okazaki-shi (JP); Kunihiro Yamada, Okazaki-shi (JP)

Correspondence Address: OLIFF & BERRIDGE, PLC, P.O. BOX 19928, ALEXANDRIA, VA, 22320, US

(73) Assignee: AISIN AW CO., LTD., Anjo-shi (JP)

(21) Appl. No.: 10/810,689

(22) Filed: Mar. 29, 2004

(30) Foreign Application Priority Data
Apr. 9, 2003 (JP) 2003-105420

(51) Int. Cl. G01C 21/26

(52) U.S. Cl. 701/200; 340/991

(57) ABSTRACT

A navigation device is provided with a communication portion that is capable of communication with a server that distributes data, and a data storage portion that stores data downloaded from the server. When start-up of the vehicular navigation device is initiated, communication with the server is executed and data is downloaded prior to the completion of start-up of the vehicular navigation device.

### INCORPORATION BY REFERENCE

The disclosure of Japanese Patent Application No. 2003-105420 filed on Apr. 9, 2003, including the specification, drawings and abstract is incorporated herein by reference in its entirety.

### BACKGROUND OF THE INVENTION

1. Field of Invention

The present invention relates to a navigation device.

2. Description of Related Art

Conventionally, systems have been provided (for example, Japanese Patent Laid-Open Publication 2001-148092) having an information center and a navigation device mounted in a vehicle that is capable of communication with the information center. In such systems, when a user, such as a driver, gets into the vehicle and starts the engine, the navigation device immediately communicates with the information center and obtains data therefrom.

With these conventional systems, while the vehicle is parked, the user can access the information center using, for example, a mobile information terminal or a personal computer in their home or at their office, and conduct a route search by inputting a target destination, search conditions, or the like. Furthermore, when the user gets into the vehicle and starts the engine, the navigation device communicates with the information center and receives the route guidance data that was searched for by wireless communication, or the like. Accordingly, when the user gets into the vehicle and starts to drive, they can use the route guidance immediately.

However, with such conventional systems, communication between the navigation device and the information center takes place after start-up of the navigation device. FIG. 2 shows a flow chart for a start-up operation of the above-described conventional navigation device.

First, when the user gets into the vehicle and starts the engine, the navigation device starts up due to an accessory signal being switched to ON. Then, a processor of the navigation device is initialized. Next, an operating system (OS) of the navigation device is initialized. Application programs, device drivers, and the like, are also initialized. The operating system starts up and a memory of the navigation device is initialized. Next, after the application programs, device drivers, and the like, have started up, it is determined whether the start-up of the navigation device is completed.

When the start-up of the navigation device is completed, the user operates an input unit of the navigation device in order to operate the navigation device. The user operates the input unit to input a request for obtaining information, such as news, from a server that functions as the information center. Accordingly, a news request is sent to the server from the navigation device. Then, the server sends news to the navigation device in response to the received news request. When the news is received from the server, the navigation device executes, for example, display of the news on a display unit, or voice output of the news from a speaker by using, for example, TTS (Text-to-Speech; registered trademark) software, which converts the characters or sentences to sound. Thus, it is possible for the user to check the news received from the server.

The operation of the flow chart of FIG. 2 summarizes the above-described process. In step S101, a processor 31 is initialized. In step S102, the operating system is initialized. Then, in step S103, the application programs, the device drivers, and the like, are initialized. Next, in step S104, the operating system starts up.

After the operating system starts up, in step S1105, the memory of the navigation device is initialized. Then, in step S106, the application programs, device drivers, and the like, start-up. In step S107, it is determined whether the navigation device has completed start-up. If start-up is completed, the operation proceeds to step S108. If start-up is not completed, the operation returns to step S107. In step S108, the user inputs a news request. In step S109, the news is received from the server. In step S110, the news is displayed or voice output.

In this manner, after start-up of the navigation device is completed, communication between the navigation device and the server acting as the information center takes place. Accordingly, it is not possible for the data received from the server to be provided to the user by displaying it on the display unit, or the like, until after start-up of the navigation device is completed. Therefore, when it is necessary to check and use the data received from the server before starting vehicle driving, it is not possible for the user to start driving the vehicle immediately.

### SUMMARY OF THE INVENTION

In light of the above-described problem of the conventional navigation device, various exemplary embodiments of this invention provide, among other things, a navigation device that allows communication between the navigation device and the server prior to completion of the start-up of the navigation device. Thus, the user may check and utilize data that is immediately received from the server following the initiation of the start-up of the navigation device but before it is completed.

Various exemplary embodiments of this invention provide a method for communicating a navigation device with a server, including instructing, prior to initiating start-up of a navigation device, a communication portion to communicate with a server; starting-up the communication portion, the communication portion connected to the navigation device; communicating with the server using the communication portion; and starting-up, after the communication portion has started-up, portions of navigation device unnecessary for communication.

Various exemplary embodiments of this invention provide a navigation device, including a communication portion that is configured to communicate with a server that distributes data; and a data storage portion that stores the data that is distributed from the server; wherein, when start-up of the navigation device is initiated, communication with the server is executed and the distributed data is downloaded prior to completion of start-up.

Various exemplary embodiments of this invention provide a storage medium storing a set of program instructions executable on a data processing device and usable for communicating a navigation device with a server, the set of program instructions including instructions for instructing, prior to initiating start-up of a navigation device, a communication portion to communicate with a server; instructions for starting-up the communication portion, the communication portion connected to the navigation device; instructions for communicating with the server using the communication portion; and instructions for starting-up, after the communication portion has started-up, portions of navigation device unnecessary for communication.

Therefore, according to various exemplary embodiments of the invention, communication with the server is executed prior to the completion of the start-up of the navigation device. Accordingly, it is possible for data to be immediately received from the server following the initiation of the start-up of the navigation device, and for the user to check and utilize this data without first waiting for the completion of the start-up.

### BRIEF DESCRIPTION OF THE DRAWINGS

Exemplary embodiments of the invention will now be described with reference to the accompanying drawings, wherein:

FIG. 1 is a flow chart showing an operation that is performed in the case that push-type content of a navigation system according to a first exemplary embodiment of the invention is downloaded;

FIG. 2 is a flow chart showing an operation that is performed when a navigation device of a conventional navigation system starts up;

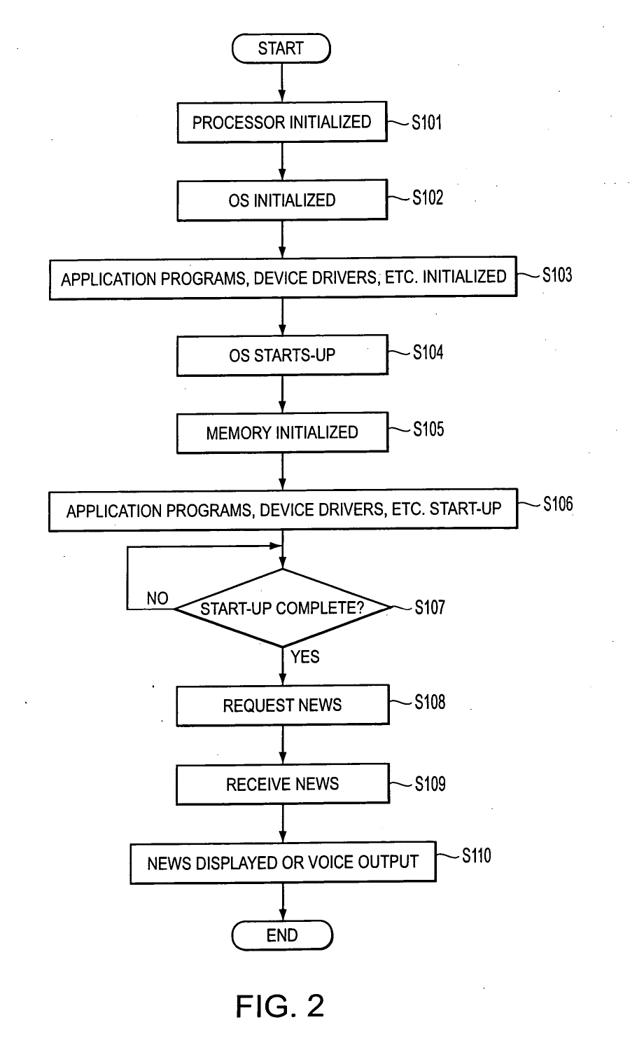

FIG. 3 shows the configuration of the navigation system according to the first exemplary embodiment of the invention;

FIG. 4 shows the configuration of a navigation device according to the first exemplary embodiment of the invention;

FIG. 5 shows a software configuration in the case that an on-board apparatus according to the first exemplary embodiment of the invention is the navigation device for a vehicle.

FIG. 6 is a flow chart showing an operation that is performed when pull-type content of the navigation system according to the first exemplary embodiment of the invention is downloaded;

FIG. 7 is a flow chart showing an operation that is performed when setting is executed such that data is not downloaded by the navigation system according to the first exemplary embodiment of the invention;

FIG. 8 shows the configuration of a navigation system according to a second exemplary embodiment of the invention; and

FIG. 9 is a flow chart showing an operation that is performed when push-type content of the navigation system according to the second exemplary embodiment of the invention is downloaded.

### DETAILED DESCRIPTION OF EXEMPLARY EMBODIMENTS

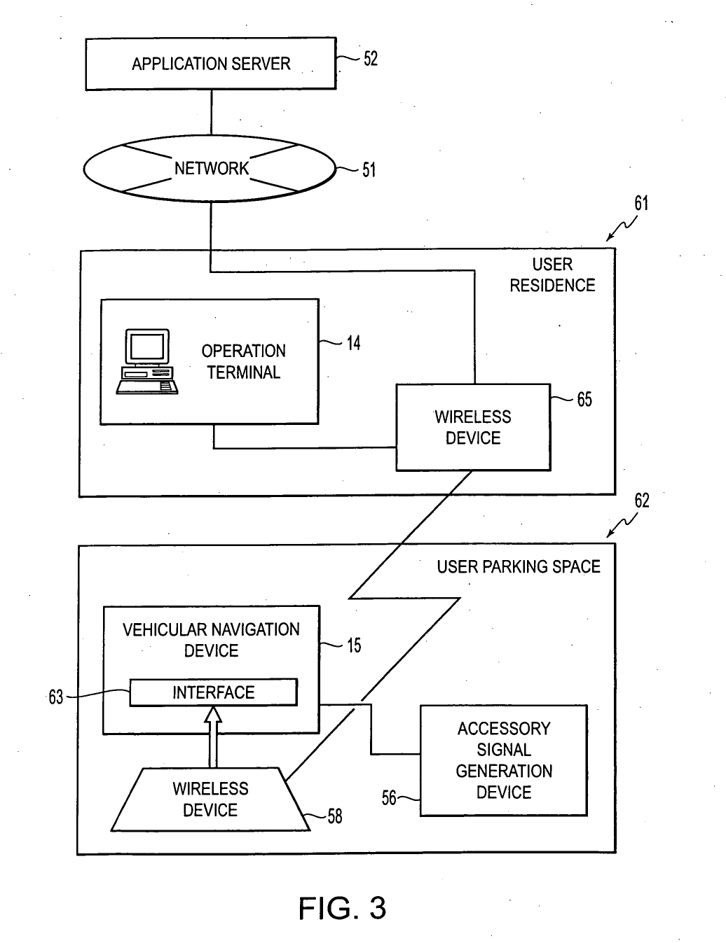

FIG. 3 shows the configuration of a navigation system in accordance with a first exemplary embodiment of the invention. As shown in FIG. 3, a vehicular navigation device 15 that is a navigation device for vehicular use is mounted in a passenger vehicle, truck, bus, motor-bike, or the like. A wireless device 58 of the vehicular navigation device 15 is connected to an interface 63 and acts as a communication portion. The wireless device 58 is, for example, a wireless LAN device, such as a wireless LAN card. The interface 63, in the case that the wireless device 58 is a wireless LAN card, is a card slot into which the wireless LAN card is inserted. Moreover, the wireless device 58 may be incorporated within the vehicular navigation device 15.

The configuration of the vehicle has been omitted from FIG. 3. However, the vehicular navigation device 15 is supplied with electric power from a main power source, which is a battery (not shown) for use in the vehicle. Further, the vehicular navigation device 15 receives an accessory signal from an accessory signal generation device 56 of the vehicle. When the accessory signal is received, the entire vehicular navigation device 15 starts up.

The vehicle (not shown) is parked in a user parking space 62, which is the parking space used by the user of the vehicle, for example, an operator, a passenger, or an owner of the vehicle. A wireless device 65 that communicates with the wireless device 58 using, for example, a wireless LAN system is provided at a user residence 61. The wireless device 65 is, for example, a wireless LAN adapter which communicates with the vehicular navigation device 15 using a wireless LAN system, by utilizing 2.4 (GHz) ISM band, 5.2 (GHz) band, or 19 (GHz) band sub-millimeter-waves, or the like, or infrared rays. The wireless LAN system in this case is, for example, IEEE802.11a, IEEE802.11b, IEEE802.11e, IEEE802.11g, Bluetooth, or the like, which is adopted as a home wireless system. Note that the wireless device 65 may be a router or a home server provided with a storage unit that is used in a home network or LAN.

In the case that communication between the wireless device 58 and the wireless device 65 is carried out using a normal wireless LAN system, the potential communication range is a range that is roughly equivalent to a circle with a radius of 10 to 100 meters around the wireless device 65. Accordingly, it is assumed that the vehicle is parked within this range.

An operation terminal 14 that is operated by the user is a type of computer that is provided with a calculation unit, such as a CPU or MPU; a memory unit, such as a semi-conductor memory or a magnetic disk; a display unit, such as a CRT, a liquid crystal display, or an LED (Light Emitting Diode) display; an input unit, such as a keyboard, a joy-stick, a touch panel, a tablet, a push button, a rotating dial or a remote controller; and an input-output interface, and the like. Further, the operation terminal 14 may be, for example, any type of device such as a personal computer, a mobile phone device, a PHS (Personal Handy-Phone System) device, a stationary telephone device, a PDA (Personal Digital Assistant), an electronic hand-held organizer, a mobile information terminal, a game machine, a digital television, or the like. The operation terminal 14 is connected to the wireless device 65 by wire or wirelessly. As a result the operation terminal 14 can communicate with the vehicular navigation device 15 via the wireless device 65.

Moreover, the wireless device 65 is connected to a network 51. The network 51 is, for example, the Internet. However, the network 51 may be any type of network such as a wired or wireless public network, a dedicate line network, an intranet, LAN, WAN (Wide Area Network), a mobile phone network, or a PHS phone network. Alternatively, the network 51 may be a plurality of types of communication networks that are suitably combined. It is preferable that an information supply device can be accessed via the network 51. The information supply device is a web server, or the like, that can supply various types of data such as map data, music data, image data, and character data. Accordingly, it is also preferable that the network 51 is capable of high capacity, high speed communication. For example, in the case that the network 51 is the Internet, a broad band connection that is capable of high speed communication at a number of Mbps (Mega bit per second) or more is preferred. However, various other communication systems may be utilized.

According to this exemplary embodiment, the wireless device 65 is a relay apparatus between the operation terminal 14 and the vehicular navigation device 15, and functions as an access point to the network 51 from the operation terminal 14 and the vehicular navigation device 15. In the case that the wireless device 65 is a router or a home server, or the like, it also functions as a storage unit that temporarily stores data that is sent and received via the network 51.

As shown in FIG. 3, an application server 52 acts as a server that is connected to the network 51, and distributes various types of data. The application server 52 is provided at an information center (not shown). The application server 52 is, for example, a type of computer that is provided with a calculation unit, such as a CPU or MPU; a memory unit, such as a semi-conductor memory or a magnetic disk; a display unit, such as a CRT, a liquid crystal display, or an LED (Light Emitting Diode) display; an input unit, such as a keyboard, a touch panel, a tablet, a push button, or a mouse; and an input-output interface, and the like. The application server 52 is, for example, a web server connected to the Internet, but it may be another type of device such as a personal computer, or a work station. The application server 52 may be configured so as to be independent. Alternatively, the application server 52 may be a distributed server that connects a plurality of servers, or one system configured within a large computer.

The application server 52 distributes, via the network 51, navigation data used by the vehicular navigation device 15, such as map data, road data, photographic data and facilities information data including information about facilities such as hotels in each region, gasoline stations and tourist information centers; update programs for the vehicular navigation device 15; software for personal information management that can be utilized by the vehicular navigation device 15; application programs, such as software for games; software for entertainment, such as music and video data; news; traffic information; and weather information. Further, the application server 52 may function as a mail server that receives, stores and transmits electronic mail; and may function as a host station for personal computer communication that provides services such as an electronic notice board, electronic meetings, and a chat service. The application server 52 may obtain data by accessing other web servers, or the like. For example, the application server 52 may distribute information such as news, traffic information, and weather information that is obtained by accessing web servers run by newspaper companies, television stations, news distribution companies, or the like.

If the application server 52 has a route search function and a position or facility search function like a normal vehicular navigation device, it is possible to establish a route, or search for locations or facilities by using the operation terminal 14 or the vehicular navigation device 15 to send the departure location, the target destination, search conditions, and the like, to the application server 52. Then, data concerning the established route, or the found location or facility, or the like, is sent back to the operation terminal 14 or the vehicle navigation device 15.

According to this exemplary embodiment, while the vehicle is parked in the user parking space 62, the vehicular navigation device 15 can communicate via wireless device 65 with the application server 52 connected to the operation terminal 14 and the network 51 using the wireless LAN system. As a result, it is possible for data to automatically download when the vehicular navigation device 15 starts up due to receiving the accessory signal from the accessory signal generation device 56. The data may be directly downloaded from the application server 52 via the network 51. Alternatively, the data may be downloaded in advance from the application server 52, stored temporarily in the wireless device 65, and then downloaded therefrom. The data referred to here includes the previously mentioned navigation device use data, the update programs, the application programs, the game use software, the entertainment use software, and data concerning news, traffic information, weather information, the established route, and found locations and facilities.

For example, if the application server 52 provides a latest version of the map data as the navigation data, the desired map data is downloaded temporarily to the operation terminal 14 or the wireless device 65 from the application server 52 via the network 51. Then, the map data is downloaded to the vehicular navigation device 15 by transferring it from the operation terminal 14 or the wireless device 65. As a result, it is possible to update the version of the map data stored in the vehicular navigation device 15. Additionally, the data may be directly downloaded to the vehicular navigation device 15 from the application server 52 without temporarily downloading it to the operation terminal 14 or the wireless device 65.

In the case that the vehicular navigation device 15 is a device capable of overwriting its drive program, the user may download an updated drive program to the vehicular navigation device 15 from the application server 52. Additionally, if the vehicular navigation device 15 is provided with vehicle audio device functions, the user can edit music using the operation terminal 14, and then transfer the music to the vehicular navigation device 15 where it is stored. Further, if the application server 52 distributes music, desired music can be temporarily downloaded to the operation terminal 14 or the wireless device 65 from the application server 52, and then transferred to the vehicular navigation device 15 where it is stored. Still further, music may be directly downloaded from the application server 52 to the vehicular navigation device 15.

If the vehicular navigation device 15 functions as a reproducer of static images and video images, and the like, it is possible to store image data for films, and the like, in the vehicular navigation device 15, in a similar manner to music. It is possible to store data for static images, video images, and the like, that have been filmed by the user with a digital camera or a video camera in the vehicular navigation device 15 by transferring the relevant data to the vehicular navigation device 15 from the operation terminal 14.

If the vehicular navigation device 15 has a function that organizes and displays timetables, schedules, and the like, the user can utilize the operation terminal 14 and use PIM (Personal Information Management) software to create data for timetables, schedules, and the like. This data can then be transferred to the vehicular navigation device 15 and stored therein.

According to this embodiment, even if the vehicle is parked at a location other than the user parking space 62, it is possible to download data to the vehicle navigation device 15. For example, if a wireless device like the wireless device 65 is provided at a parking lot at a destination other than the user parking space 62 (for example, in the parking lot of a commercial facility, such as a department store, a supermarket, or a convenience store; the parking lot of a amusement facility, like a theme park or a game center; the parking lot at a eating or drinking establishment, such as a fast-food restaurant or a coffee shop; or a parking lot at the periphery of a transportation-related facility, such as a station or an airport; or at a gasoline station), it may still be connected to the network 51 through another wireless device (not shown), like the wireless device 65. In this case, in the same manner as when the vehicle is parked in the user parking space 62, it is possible to download map data, music, video data, and the like, to the vehicular navigation device 15 from the application server 52 by using the wireless LAN system. Accordingly, even at the journey destination, it is possible for the user to download desired data to the vehicular navigation device 15.

Additionally, according to this embodiment, the vehicle may be parked at a pay parking lot with a wireless device (not shown), similar to the wireless device 65, connected to a computer that manages the pay parking lot. If data concerning the vehicle's parking time and parking fees that is managed by the computer is provided, this data may be downloaded to the vehicular navigation device 15 by using the wireless LAN system.

The computer that manages the pay parking lot may provide information about various facilities like department stores and theme parks in the vicinity of the pay parking area. For example, data related to internal maps of the facilities, special offers, prize offers, opening times, special events, and the like may be provided. In this case, the data related to the various facilities may be downloaded to the vehicular navigation device 15 using the wireless LAN system. Accordingly, it is possible for the user to obtain data related to the various facilities in the vicinity of the pay parking lot.

In addition, according to this embodiment, the vehicle may be parked in a parking space with a parking meter on a road, with a wireless device (not shown), like the wireless device 65, that is connected to the network 51 being provided in the parking meter. As a result, it is possible to download map data, music, video data, and the like, to the vehicular navigation device 15 from the application server 52 using the wireless LAN system in a similar manner to when the vehicle is parked in the user parking space 62. Accordingly, the user can download desired data to the vehicle navigation device 15 even when at a journey destination.

Further, according to this embodiment, the vehicle may be parked in a parking lot at the user's place of work, with a wireless device (not shown), like the wireless device 65, that is connected to the network 51 being provided in the parking lot. As a result, it is possible to download map data, music, video data, and the like, to the vehicular navigation device 15 from the application server 52 using the wireless LAN system in a similar manner to when the vehicle is parked in the user parking space 62. Accordingly, the user can download desired data to the vehicle navigation device 15 even when at work.

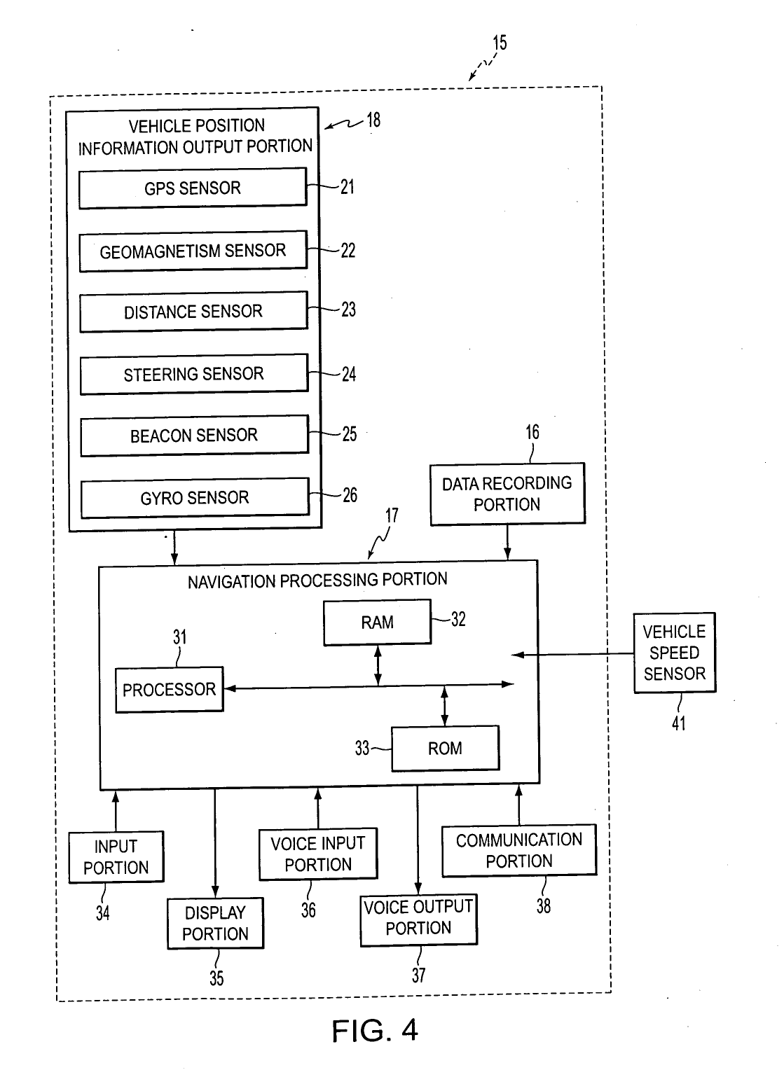

Next, the configuration of the vehicular navigation device 15 of the first exemplary embodiment will be explained with reference to FIG. 4. FIG. 4 shows the configuration of the vehicular navigation device 15 according to the first exemplary embodiment of the invention.

In this exemplary embodiment, the vehicular navigation device 15 is, for example, a type of computer. In terms of function, as shown in FIG. 4, the vehicular navigation device 15 has a vehicle position information output portion 18 that detects a present position of the vehicle and which outputs vehicle position information; a data recording portion 16 that acts as a recording medium in which road data, and the like, is recorded; a navigation processing portion 17 that executes various types of processing such as navigation processing; an input portion 34; a display portion 35; a voice input portion 36; a voice output portion 37; and a communication portion 38. It should be noted that the navigation processing portion 17 is connected to a vehicle speed sensor 41.

Moreover, the vehicle position information output portion 18 is configured to include, for example, a GPS (Global Positioning System) sensor 21, a geomagnetism sensor 22, a distance sensor 23, a steering sensor 24, a beacon sensor 25, a gyro sensor 26, and an altimeter (not shown). It should be appreciated that, as appropriate, one or more of the GPS sensor 21, the geomagnetism sensor 22, the distance sensor 23, the steering sensor 24, the beacon sensor 25, the gyro sensor 26, and the altimeter, may be omitted or combined based on production cost, resources, and/or the like.

The GPS sensor 21 detects a present position on the earth based on reception of a radio wave generated by a man-made satellite. The geomagnetic sensor 22 detects the directional orientation of the vehicle based on measurement of geomagnetism. The distance sensor 23 determines a distance between the vehicle and a given position on the road. The distance sensor 23 may be, for example, a device that estimates a number of revolutions of the vehicle wheels and detects the distance based on the revolutions. Alternatively, a device that estimates an acceleration rate and detects the distance by performing double integration of this acceleration rate may be used.

The steering sensor 24 detects a steering angle. The steering sensor 24 may be, for example, an optical rotation sensor or a rotating resistance sensor attached to a rotating portion of a steering wheel, or an angle sensor attached to the wheels.

The beacon sensor 25 detects a present position based on reception of position information from beacons provided along the road. The gyro sensor 26 detects a rotational angular velocity of the vehicle, namely, a turning angle. The gyro sensor 26 may be, for example, a gas rate gyro, a vibration gyro, or the like. Moreover, it is possible to detect the directional orientation of the vehicle by integrating the turning angle detected by the gyro sensor 26.

Note that each of the GPS sensor 21 and the beacon sensor 25 can independently detect the present position. It is also possible to detect the present position by combining the distance detected by the distance sensor 23, and the directional orientation detected by the geomagnetism sensor 22 and the gyro sensor 26. In addition, it is possible to detect the present position by combining the distance detected by the distance sensor 23 and the steering angle detected by the steering sensor 24.

The data recording portion 16 is provided with a data base composed of, for example, map data files, intersection data files, node data files, road data files, photograph data files, and facility information data files, in which information about hotels in each region, gasoline stations, tourist information centers, and the like, is recorded. Various other types of data, detailed below, for display on a screen (not shown) of the display portion 35 are recorded in the data recording portion 16. This display data includes, for example, guidance maps for along the established route, photographs, split screen maps that show intersections or key features along the route, distances to upcoming intersections and direction of travel at upcoming intersections, and other guidance information. Note that various types of data for outputting predetermined information using the voice output portion 37 may also recorded in the data recording portion 16.

It should be appreciated that intersection data, node data, and road data may be respectively recorded in the intersection data files, the node data files, and road data files. Road conditions may be displayed on the screen using the intersection data, the node data and the road data. The intersection data includes the type of the various intersections, for example, whether an intersection has traffic lights. The node data includes, at the least, the positions and shapes of the roads of the map data recorded in the map data files. This node data is comprised of, for example, data that shows branch points of actual roads (including intersections, T-junctions, and the like), node points, and links that connect each of the node points. In addition, the node points, at the least, indicate the position of bends in the roads.

The road data includes, for example, data about the road itself, for example, road width, gradient, cant, altitude, bank, the state of the road surface, the number of road lanes, points where the number of road lanes reduces, points where the width of the road narrows, and the like. Note that, in the case of a highway or an arterial road, data for the lanes on opposing sides is stored respectively as separate road data, and processed as two separate roads. For example, in the case of an arterial road with two lanes or more on each side, the data for the arterial road is processed as two separate roads and stored in the road data as respective independent roads. One road for representing the upstream lane and one road for representing the downstream lane. With regard to corners, data is included, such as curve radius, intersections, T-junctions, and corner entry points. With regard to road attributes, data is included, such as railway crossings, highway entry-exit ramp ways, highway toll-collection booths, downward sloping roads, upward sloping roads, and road type (e.g., national routes, principal local roads, ordinary roads, express highways).

The navigation processing portion 17 is configured to include, for example, a processor 31 that acts as a calculation unit for the CPU, MPU, and the like, that executes overall control of the vehicular navigation device 15; a RAM 32 that is used as working memory when the processor 31 executes various types of calculation processing; and a ROM 33 that acts as a storage medium on which control programs, as well as various other types of programs are stored. The various other types of programs, for example, execute route searches, provide running guidance along the route, search for locations and facilities, and the like.

The navigation processing portion 17 is connected to the input portion 34, the display portion 35, the voice input portion 36, the voice output portion 37, and the communication portion 38, and thus allows for the communication of route searches, provision of running guidance along the route, and searches for locations, facilities, and the like.

The storage medium on which the navigation programs are stored is computer-readable and is not limited to being a semi-conductor memory. The storage medium may be any form of storage medium, such as, for example, a magnetic tape, a magnetic disk, a magnetic drum, a CD-R/W, an MD, a DVD-RAM, a DVD-R/W, an optical disk, an MO, an IC card, an optical card, or a memory card.

The data recording portion 16 and the ROM 33 are configured from, for example, a magnetic core, a semi-conductor memory, or the like. Further, the data recording portion 16 and the ROM 33 may also use any type of storage medium, such as, for example, a magnetic tape, a magnetic disk, a magnetic drum, a CD-R!W, an MD, a DVD-RAM, a DVD-R/W, an optical disk, an MO, an IC card, an optical card, or a memory card. The storage medium may be installed in advance in the vehicular navigation device 15, and can be replaced as appropriate by the user.

According to this exemplary embodiment, various programs are stored in the ROM 33, and various types of data are stored in the date recording portion 16. However, the programs and the data may be stored in the same manner in an external storage medium. In this case, for example, a storage medium like a flash memory, or the like (not shown) is provided in the navigation processing portion 17, whereby it is possible to read the programs and the data from the external storage medium and write them on the storage medium. Accordingly, it is possible to update the programs and the data by replacing the external storage medium. In this manner, it is possible to start up the various programs stored on the storage medium and execute various types of processing based on the data. Note that, the external storage medium may be of any type, such as, for example, a magnetic tape, a magnetic disk, a magnetic drum, a CD-R/W, an MD, a DVD-RAM, a DVD-R/W, an optical disk, an MO, an IC card, an optical card, or a memory card.

According to this exemplary embodiment, the communication portion 38 is provided with the card slot as the interface 63, and communicates with the wireless device 65 via the wireless LAN card which is inserted in the card slot as the wireless device 58. Moreover, the communication portion 38, for example, can receive various types of data, such as road information about traffic congestion, and the like, received from an information sensor, or the like, not shown; traffic accident information; and D-GPS information that detects a detection difference (error) of the GPS sensor 21. Further, the communication portion 38 is preferably provided with a specific low power wireless device (not shown). In addition, according to this embodiment, when data distributed from the application server 52 connected to the network 51 is downloaded by the communication portion 38, the data is downloaded to a readable/writeable memory device, such as a storage medium which may be, for example, the RAM 32, a flash memory, a hard disk, or the like. In this case, the storage medium functions as a data storage portion and stores the data downloaded from the application server 52. It is possible to use the operation terminal 14 such that the data distributed from the application server 52 is temporarily downloaded to the operation terminal 14 and then is downloaded to the storage medium of the vehicular navigation device 15 from the operation terminal 14.

The input portion 34 is configured to include, for example, an operation key, a push button, a jog dial, a cross-shaped switch-key, or the like, that is provided on a body of the vehicular navigation device 15. The input portion 34 is used, for example, to correct the vehicle position and input the destination. Note that, the input portion 34 may also be a remote controller. Further, in the case that the display portion 35 has a touch panel, it is preferable that the input portion 34 is configured from an operation switch like an operation key or an operation menu that is displayed on the screen of the display portion 35. In this case, it is possible to execute input by pushing or touching the operation switch on the panel.

Operation guidance, an operation menu, guidance about the operation key, the route from the present position to the destination, guidance information along the route, and the like, are displayed on the screen of the display portion 35. For the display portion 35, it is possible to use, for example, a CRT display, a liquid crystal display, an LED display, a plasma display, a hologram device which projects a hologram on to a windshield, or the like.

The voice input portion 36 is configured from a microphone, or the like, and makes it possible to input necessary information by voice. Further, the voice output portion 37 is provided with a voice synthesis device and a speaker. The voice output portion 37 provides the user with audio information by using the speaker to output audio information such as, for example, guidance information and speed shift information, which is generated by a voice that is synthesized by the voice synthesis device. Note that, in addition to the voice synthesized by the voice synthesis device, the voice output portion 37 may use the speaker to output various types of sounds, and various types of guidance information that are pre-recorded on a tape, a memory, or the like.

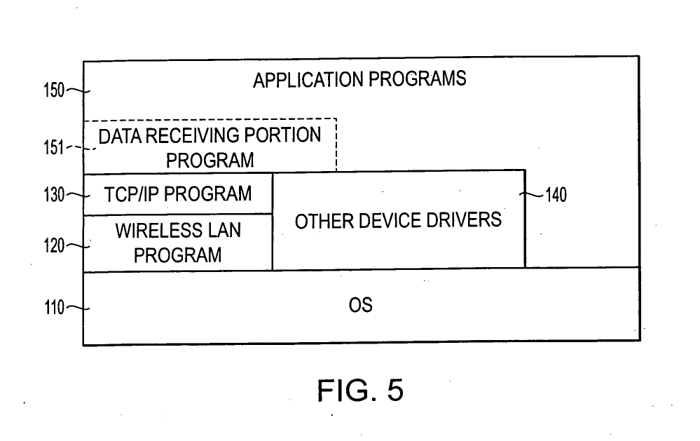

Hereinafter, a software configuration of the vehicular navigation device 15 according to the first embodiment will be described with reference to FIG. 5. FIG. 5 shows the software configuration in the case that an on-board apparatus according to the first embodiment of the present invention is the navigation device for the vehicle.

In this exemplary embodiment, the operating system (OS) 110 installed in the vehicular navigation device 15 may be of any type, for example, Windows (registered trademark) or MAC OS (registered trademark) that are used in standard personal computers. In addition, a network driver that is run by the operating system may be a wireless LAN program 120 and TCP/IP (Transmission Control Protocol/Internet Protocol) program 130 that functions as a device driver for the wireless device 65. This network driver is installed in the vehicular navigation device 15. It should be noted that other device drivers 140 for devices other than the wireless device 65 are also installed in the vehicular navigation device 15.

The application programs 150 for executing the navigation processing, and the like, are installed in the vehicular navigation device 15. Note that the application program includes a program 151 for a data receiving portion that receives data.

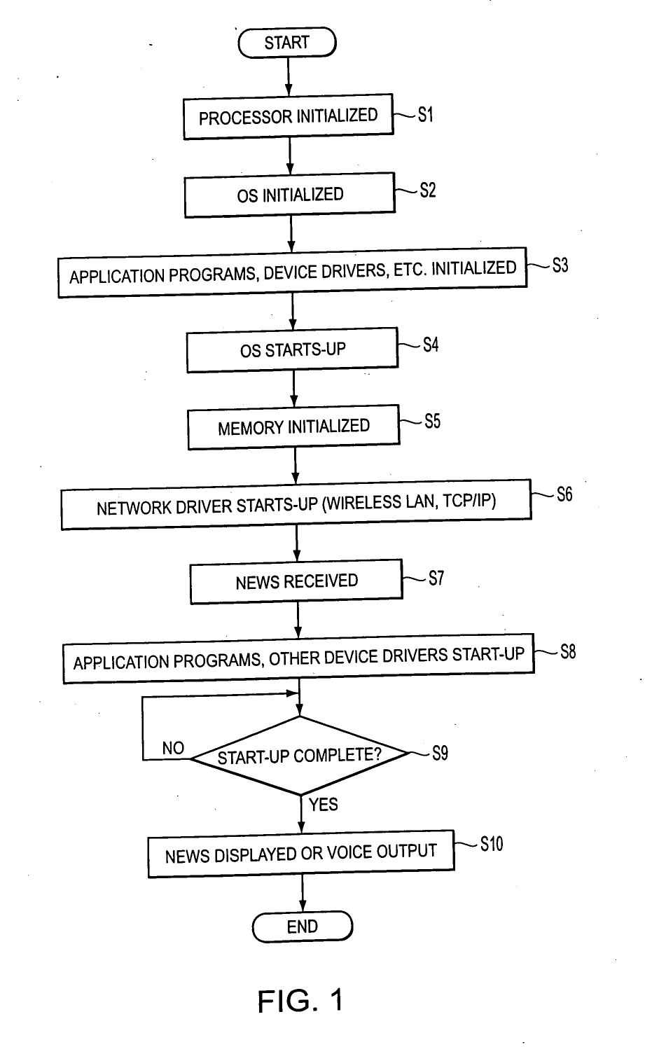

Next, the operation of the navigation system with the above described configuration will be explained with reference to FIG. 1. FIG. 1 is a flow chart showing an operation that is performed in the case that push-type content of the navigation system according to the first exemplary embodiment of the invention is downloaded.

According to this exemplary embodiment, in the case that the vehicular navigation device 15 is set to download data when it starts up, the data is downloaded from the application server 52 before the vehicular navigation device 15 completes start-up. It should be appreciated that the data may be any type of data, and furthermore, the data may be downloaded temporarily to the operation terminal 14 or the wireless device 65, and then transferred to the vehicular navigation device 15 thereafter. However, for ease of explanation, an operation where news is directly downloaded to the vehicular navigation device 15 from the application server 52 will be explained.

The user operates the vehicular navigation device 15 in advance and executes a setting such that news is automatically downloaded from the application server 52 when the vehicular navigation device 15 starts up due to receiving the accessory signal from the accessory signal generation device 56. Note that the vehicular navigation device 15 may be set with a default setting (initial setting) such that when start up takes places, the news is automatically downloaded from the application server 52. Further, the vehicular navigation device 15 may be set to download in accordance with settings set by the user the last time the vehicular navigation device 15 was operated.

According to this example, the vehicular navigation device 15 is set to directly download the news from the application server 52 via the wireless device 65 and the network 51. Accordingly, the news is push-type content that is transferred by the application server 52 using “push-technology.” When the vehicular navigation device 15 is connected to the network 51 via the wireless device 65, this push-type content news is pro-actively transmitted to the vehicular navigation device 15 from the application server 52. Further, the fact that news is downloaded to the vehicular navigation device 15 is pre-recorded in the application server 52.

According to this embodiment, it is also possible to execute setting such that data other than the news is downloaded to the vehicular navigation device 15 when start up takes place. In this case, in addition to push-type content, the vehicular navigation device 15 may download and pro-actively obtain pull-type content by accessing the application server 52. It is also possible to execute setting such that no data whatsoever is downloaded when the vehicular navigation device 15 starts up.

In operation, first, the user turns a switch (not shown) of the accessory signal generation device 56 provided in the vehicle to ON, whereby the accessory signal generation device 56 switches the accessory signal to ON. In a normal vehicle, the switch of the accessory signal generation device 56 is formed integrally with an ignition switch for an engine. Accordingly, when the user gets into the vehicle and starts the engine, the accessory signal is switched to ON. Note that, when the ignition switch is turned to ON, the switch of the accessory signal generation device 56 is also turned to ON. However, according to this exemplary embodiment, the configuration is such that, in addition, the accessory signal generation device 56 alone can be turned to ON. When the accessory signal is switched to ON, electric power is supplied to the vehicular navigation device 15, thus causing the vehicular navigation device 15 to start up.

Next, the processor 31 of the vehicular navigation device 15 is initialized. Then, the operating system 110 of the vehicular navigation device 15 is initialized and the application programs 150, 151, the device drivers 120, 130, 140, and the like, are initialized. Following this, the operating system 110 starts up, and the storage medium of the vehicular navigation device 15, which is the memory such as the RAM 32, and the like, is initialized.

Next, the wireless LAN program 120 and the TCP/IP program 130, which act as the network driver run by the operating system 110, start up. Accordingly, the wireless device 58 that acts as the communication portion starts up, communication is established with the wireless device 65 provided at the user residence 61, and the vehicular navigation device 15 is connected to the network 51. Then, the news, which is the push-type content, is transmitted to the vehicular navigation device 15 from the application server 52 connected to the network 51. Accordingly, the vehicular navigation device 15 receives the news from the application server 52. The received news is stored in the storage medium, which is, for example, the RAM 32, acting as the data storage portion. Note that, at this time, the program for the data receiving portion 151, which is one of the application programs 150, has already been started up. It should be appreciated that the news may be obtained by the application server 52 by accessing a web server that is operated by a newspaper company, a television station, or a news distribution company.

Next, the application programs 150 and other device drivers 140 start up. Accordingly, the vehicular navigation device 15 can execute the navigation processing. Then, once all of the application programs 150, 151 and the device drivers 120, 130, 140 have started up, it is determined whether start up of the vehicular navigation device 15 is completed.

If it is determined that start up of the vehicular navigation device 15 is completed, the received news stored on the storage medium is displayed on the screen of the display portion 35 or voice output from the voice output portion 37 using TTS. Accordingly, the user is able to check the news received from the application server 52. With this, the processing for downloading the news is completed.

The above-described operation is summarized in the flow chart of FIG. 1. As shown in FIG. 1, in step S1, the processor 31 is initialized. In step S2, the operating system 110 is initialized. Then, in step S3, the application programs 150, 151, the device drivers 120, 130, 140, and the like, are initialized. Next, in step S4, the operating system 110 starts up.

After the operating system 110 starts up, in step S5, the memory of the vehicular navigation device 15 is initialized. In step S6, the wireless LAN program 120 and the TCP/IP program 130, which act as the network driver, start-up. Then, in step S7, the news is received from the application server 52. Next, in step S8, the application programs 150, 151 and the other device 140 drivers start-up. In step S9, it is determined whether the vehicular navigation device 15 has completed start-up or not. If start-up is completed, operation proceeds to step S10. If start-up is not completed, operation returns to step S9. In step S10, the news is displayed or voice output.

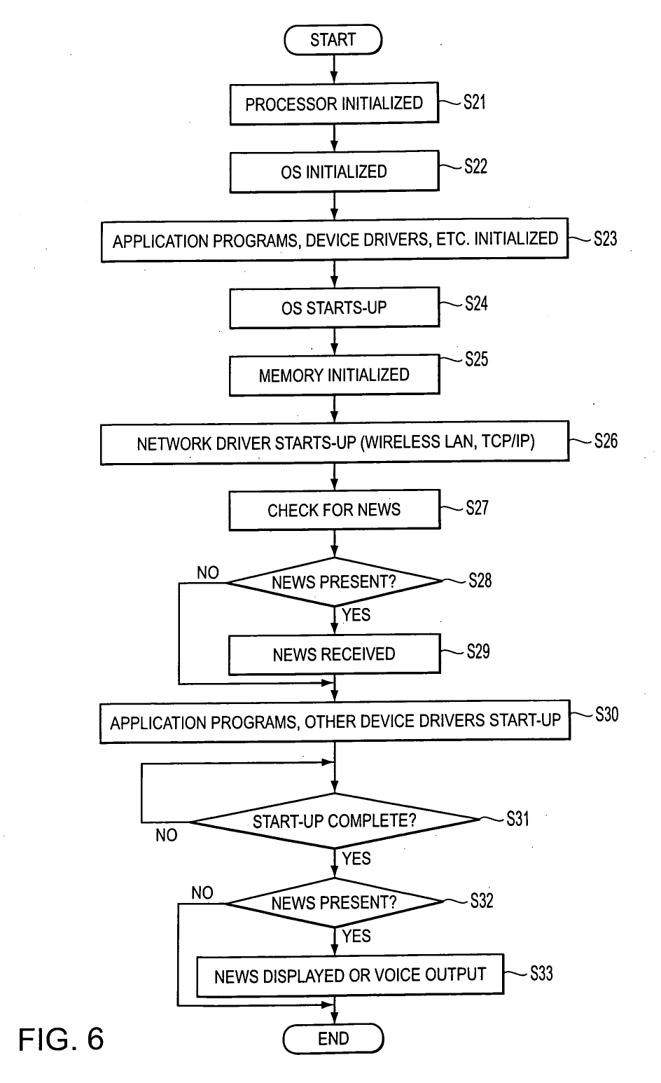

Next, an operation will be explained where the vehicle navigation device 15 accesses the application server 52 in order to download and pro-actively obtain pull-type content, with reference to FIG. 6. FIG. 6 is a flow chart showing the operation that is performed in the case that the navigation system according to the first exemplary embodiment of the present invention downloads pull-type content.

Note that, in this example, the pull-type content is news. In the case that it is possible to obtain specific types of news, setting can be executed such that these specific types of news are downloaded. For example, the user may operate the vehicular navigation device 15 in advance to execute setting such that only specific types of news, like sports news, economics news, entertainment news, or the like, are downloaded from the application server 52. Alternatively, a setting may be executed such that only non-updated news, namely, news that has not yet been downloaded, is downloaded from the application server 52 or such that only news reported since the evening of the previous day is downloaded from the application server 52. Note that, the vehicular navigation device 15, for its default setting, may be set to download only predetermined types of news. Alternatively, the vehicular navigation device 15 may be set to download in accordance with settings set by the user the last time the vehicular navigation device 15 was operated.

The operation from when the user turns the switch of the accessory signal generated device 56 provided in the vehicle to ON, until when the wireless LAN program 120 and the TCP/IP program 130 that act as the network driver start-up is the same as that for when push-type content is downloaded. Accordingly, the explanation will be omitted.

Once the vehicular navigation device 15 is connected to the network 51, the vehicular navigation device 15 accesses the application server 52 and checks whether any of the pre-specified types of news are present in the application server 52. Then, the vehicular navigation device 15 determines whether there is any news based upon the check result. In the case there is news, the news is received from the application server 52. Note that the received news is stored in the storage unit, which is, for example, the RAM 32, that acts as the data storage portion. In this case, it is assumed that the program for the data receiving portion 151 has already been started up. Following this, the application programs 150 and the other device drivers 140 start-up. In the case that there is no news, the application programs 150 and the other device drivers 140 start-up without reception of the news taking place.

Once all of the application programs 150, 151 and the other device drivers 140 have started up, it is determined whether start-up of the vehicular navigation device 15 is completed. If start up is completed, it is determined whether the vehicular navigation device 15 has any received news or not. If there is received news, this news, which is stored in the storage medium, is displayed on the screen of the display portion 35 or voice output from the voice output portion 37 using TTS. Accordingly, the user is able to check the specified news received from the application server 52. Once the user has received the news, the process of downloading the news is completed. Note that when there is no received news, processing for downloading the news is terminated.

The above-described operation is summarized in the flow chart of FIG. 6. As shown in FIG. 6, in step S21, the processor 31 is initialized. In step S22, the operating system 110 is initialized. Then, in step S23, the application programs 150, 151, the device drivers 120, 130, 140, and the like, are initialized. In step S24, the operating system 110 starts up. Then, in step S25, the memory of the vehicular navigation device 15 is initialized.

After the memory is initialized, in step S26, the wireless LAN program 120 and the TCP/IP program 130 that act as the network driver start-up. Then, in step S27, it is checked whether there is any news. In step S28, it is determined whether there is any news in the application server 52.

If there is news, operation proceeds to step S29. If there is not any news, operation jumps to step S30. In step S29, the news is received from the application server 52. Then, in step S30, the application programs 150, 151 and the other device drivers 140 start-up. Next, in step S31, it is determined whether the vehicular navigation device 15 has completed start-up or not.

If start-up is completed, the routine proceeds to step S32. If start-up is not completed, the routine returns to step S31. In step S32, it is determined whether there is any received news. If there is received news, the routine proceeds to step S33. If there is not received news, the operation is terminated. In step S33, the news is displayed or voice output.

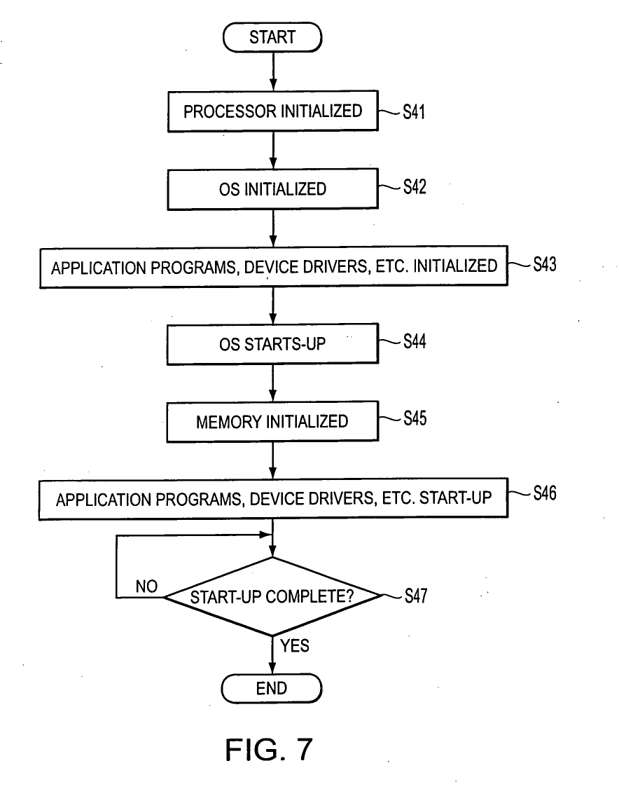

Next, an explanation will be given of an operation when setting is executed such that downloading does not take place when the vehicular navigation device 15 starts up with respect to FIG. 7. FIG. 7 is a flow chart showing the operation that is performed when setting is executed such that data is not downloaded by the navigation system according to the first exemplary embodiment of the invention.

Note that, in this example, the user operates the vehicular navigation device 15 in advance to execute setting such that no data whatsoever is downloaded when the vehicular navigation device 15 starts up.

When the user turns the switch of the accessory signal generation device 56 provided in the vehicle to ON, the accessory signal is switched to ON and electric power is supplied to the vehicular navigation device 15 causing it to start up. Then, the vehicular navigation device 15 is initialized. Next, the processor 31 of the vehicular navigation device 15 is initialized. The operating system 110 of the vehicular navigation device 15 is initialized, and in addition, the application programs 150, 151, device drivers 120, 130, 140, and the like, are initialized. Following this, the operating system 110 starts up, and the storage medium, which is, for example, the memory such as the RAM 32, is initialized.

Next, the application programs 150, 151 and the device drivers 120, 130, 140 start up. Accordingly, the vehicular navigation device 15 can execute the navigation processing. Then, following start up of all of the application programs 150, 151 and the device drivers 120, 130, 140, it is determined whether start up of the vehicular navigation device 15 is completed. Following this, in the case that start up is completed, the processing is terminated.

The above-described operation is summarized in the flow chart of FIG. 7. As shown in FIG. 7, in step S41, the processor 31 is initialized. In step S42, the operating system 110 is initialized. Then, in step S43, the application programs 150, 151, the device drivers 120, 130, 140, and the like, are initialized. In step S44, the operating system 110 starts up. Next, in step S45, the memory of the vehicular navigation device 15 is initialized.

After the memory is initialized, in step S46, the application programs 150, 151, device drivers 120, 130, 140, and the like, start-up. Then, in step S47, it is determined whether the vehicular navigation device 15 has completed start-up. If start-up is completed, operation is terminated. If start-up is not completed, operation returns to step S47.

In this manner, according to this exemplary embodiment, when setting is executed such that data is downloaded when the vehicular navigation device 15 starts up, the data is downloaded from the application server 52 prior to completion of start-up of the vehicular navigation device 15. As a result, as soon as start-up of the vehicular navigation device 15 is completed, the data is displayed on the screen of the display portion 35 or voice output from the voice output portion 37. Accordingly, the user is able to rapidly check and use the data.

Moreover, at the time of start-up, the vehicular navigation device 15 starts up the network driver 120, 130 prior to the other device drivers 140 and application programs 150, 151, and executes communication. Accordingly, the speed of communication processing is increased, and it is possible to rapidly download data.

Conventionally, the other device drivers (140) and application programs (150, 151) are assigned higher priority in the processing of the processor 31 than the network driver (120, 130). Accordingly, when the other device drivers (140) and application programs start-up (150, 151), the tasks of the other device drivers (140) and application programs (150, 151) interrupt the tasks of the network driver (120, 130), whereby the processing of the processor 31 is slowed. However, according to the above-described exemplary embodiment, the network driver 120, 130 is started up prior to the other device drivers 140 and application programs 150, 151. Thus, the tasks of the other device drivers 140 and application programs 150, 151 do not cause interruption, and the tasks of the network driver 120, 130 are processed by the processor 31 without interruption. Accordingly, the speed of the communication processing is increased, and it is possible to quickly download data.

In addition, according to the above-described first exemplary embodiment, the user can operate the vehicular navigation device 15 in advance to execute setting such that only certain types of required data are downloaded. Accordingly, the user can quickly check and use the required data when the vehicular navigation device 15 starts up. Non-required data is not downloaded. Thus, the user is saved the trouble and time of having to download and check non-required data.

Moreover, because the user can operate the vehicular navigation device 15 in advance to execute setting such that no data whatsoever is downloaded, non-required data is not downloaded and the user is saved the trouble and time of having to download and check non-required data.

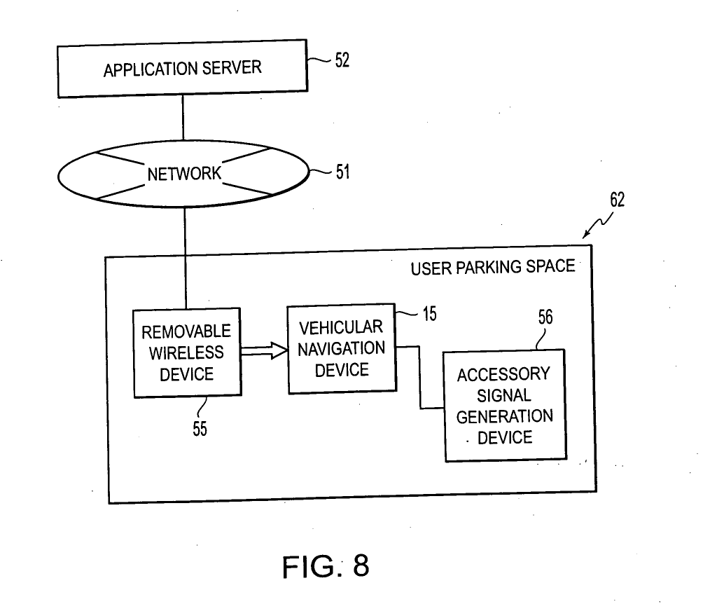

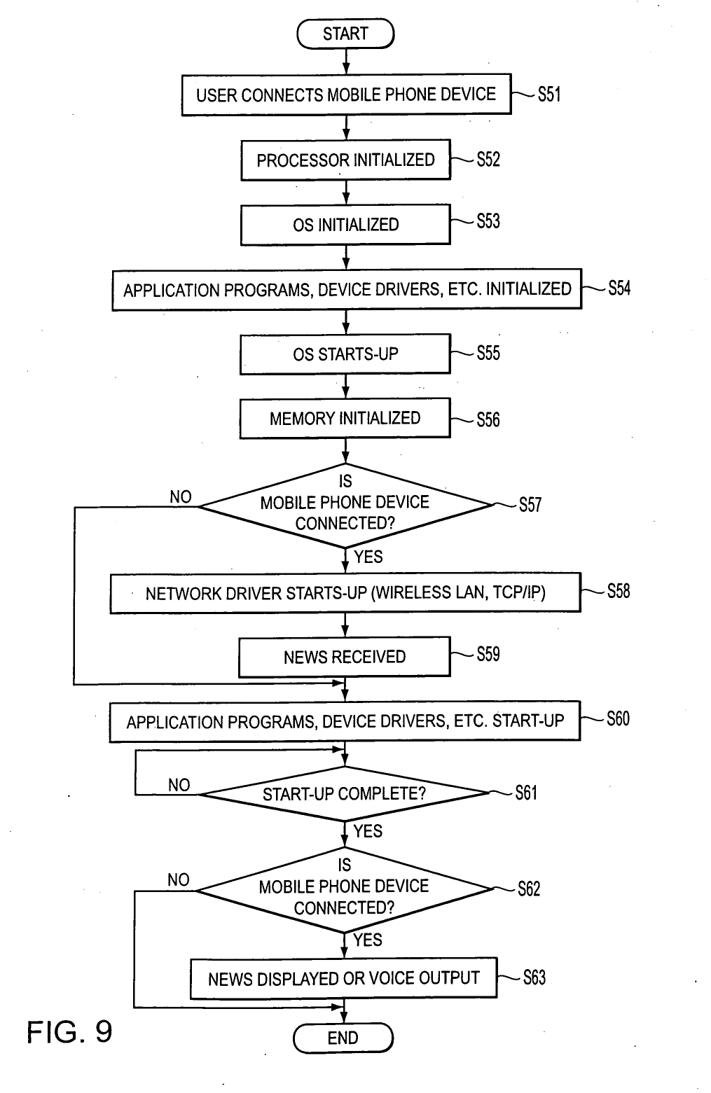

Next, a second exemplary embodiment of the invention will be explained with reference to FIGS. 8 and 9. Note that elements having the same structure as elements described in the first exemplary embodiment are denoted with the same reference numerals and an explanation thereof is omitted. Further, an explanation of operations and effects that are the same as those described in the first embodiment is also omitted.

FIG. 8 shows the configuration of a navigation system according to the second exemplary embodiment of the invention. According to this exemplary embodiment, a removable wireless device 55 is adopted instead of the wireless device 58 of the first exemplary embodiment. The removable wireless device 55 is, for example, a cellular terminal like a mobile phone device or a PHS phone device. However, it is possible to use any device which has a mobile communication function and which can be connected with the network 51 so as to allow communication. Further, the user can, when necessary, connect the removable wireless device 55 to the vehicular navigation device 15 via a connection cable, wirelessly, or the like. Accordingly, the vehicular navigation device 15 can be connected to the network 51 so as to allow communication.

According to this embodiment, the removable wireless device 55 is connected more directly with the network 51 so as to allow communication. Thus, the wireless device 58 and the operation terminal 14 provided in the user residence 61 in the first exemplary embodiment are no longer necessary. The configuration of other elements of the second exemplary embodiment are the same as those of the first embodiment, and thus an explanation is omitted.

Next, an operation that is performed when data is downloaded when start up of the vehicular navigation device 15 according to the second embodiment takes place will be explained with reference to FIG. 9. FIG. 9 is a flow chart showing an operation that is performed when push-type content of the navigation system according to the second embodiment of the present invention is downloaded.

According to the second exemplary embodiment, in a similar manner to the first exemplary embodiment, when setting is executed such that data is downloaded when the vehicular navigation device 15 starts up, data is downloaded from the application server 52 prior to the completion of start-up of the vehicular navigation device 15. Moreover, the data may be any type of data. Again, for ease of explanation, an explanation will be given for the case when the data is news.

For the purpose of the explanation, it is assumed that the user has operated the vehicle navigation device 15 in advance to execute setting such that news is automatically downloaded from the application server 52 when the vehicular navigation device 15 starts up as a result of receiving the accessory signal from the accessory signal generation device 56. The vehicular navigation device 15 may be set with a default setting such that when start-up takes places the news is automatically download from the application server 52. Moreover, the vehicular navigation device 15 may be set to download in accordance with settings set by the user the last time the vehicular navigation device 15 was operated.

Further, prior to start-up of the vehicular navigation device 15, the user connects the removable wireless device 55 to the vehicular navigation device 15 using the connection cable, wirelessly, or the like. In this example, the removable wireless device 55 is a mobile phone device. Accordingly, the vehicular navigation device 15 can directly download news from the application server 52 via the network 51. In this case, the news is push-type content. When the vehicular navigation device 15 is connected to the network 51 via the mobile telephone device, this news is pro-actively transmitted to the vehicular navigation device 15 from the application server 52. Further, the fact that news is downloaded to the vehicular navigation device 15 is pre-recorded in the application server 52.

According to this exemplary embodiment, it is possible to execute setting such that data other than the news is downloaded to the vehicular navigation device 15 when start up takes place. In addition to push-type content, the vehicular navigation device 15 may download and pro-actively obtain pull-type content by accessing the application server 52. Further, it is possible to execute setting such that no data whatsoever is downloaded when the vehicular navigation device 15 starts up.

In operation, first, the user connects the mobile telephone device, which acts as the removable wireless device 55, to the vehicular navigation device 15 using the connection cable, wirelessly, or the like. Next, the user turns the switch (not shown) of the accessory signal generation device 56 provided in the vehicle to ON, whereby the accessory signal switches to ON. Accordingly, electric power is supplied to the vehicular navigation device 15 and the vehicular navigation device 15 starts up.

Next, the processor 31 of the vehicular navigation device 15 is initialized. Then, the operating system 110 of the vehicular navigation device 15 is initialized, and in addition, the application programs 150, 151, device drivers 120, 130, 140, and the like, are initialized. Following this, the operating system 110 starts up, and the storage medium of the vehicular navigation device 15, which is the memory such as the RAM 32, and the like, is initialized.

Next, it is determined whether the vehicular navigation device 15 is connected to the mobile phone device (55). Then, in the case that the mobile phone device (55) is connected, the wireless LAN program 120 and the TCP/IP program 130 that act as the network driver run by the operating system 110 start up. Accordingly, the vehicular navigation device 15 is connected to the network 51 via the mobile phone device (55). Then, the news, which is the push-type content from the application server 52 connected to the network 51, is transmitted to the vehicular navigation device 15. Accordingly, the vehicular navigation device 15 receives the news from the application server 52. The received news is stored in the storage medium, which is, for example, the RAM 32, acting as the data storage portion. Note that, at this time, the program for the data receiving portion 151, which is one of the application programs 150, has already been started up.

Next, the application programs 150 and the other device drivers 140 start up. Accordingly, the vehicular navigation device 15 can execute the navigation processing. Note that, in the case that the mobile phone device (55) is not connected, the application programs 150, 151 and device drivers 120, 130, 140 start up in that state. Then, once all of the application programs 150, 151 and the device drivers 120, 130, 140 have started up, it is determined whether start up of the vehicular navigation device 15 is completed.

If it is determined that start up of the vehicular navigation device 15 is completed, it is then determined whether the mobile phone device (55) is connected to the vehicular navigation device 15. If the mobile phone is connected, the news stored on the storage medium is displayed on the screen of the display portion 35 or voice output from the voice output portion 37 using TTS. Accordingly, the user is able to check the specified types of news received from the application server 52. With this, operation for downloading the news is completed. Note that, in the case that the mobile phone device (55) is not connected, the processing for downloading the news is completed as is.

The above-described operation is summarized in the flow chart of FIG. 9. As shown in FIG. 9, in step S51, the user connects the mobile phone device (55) to the vehicular navigation device 15. In step S52, the processor 31 is initialized. Then, in step S53, the operating system 110 is initialized. Next, in step S54, the application programs 150, 151, the device drivers 120, 130, 140, and the like, are initialized. In step S55, the operating system 110 starts up. In step S56, the memory of the vehicular navigation device 15 is initialized.

After the memory is initialized, in step S57, it is determined whether the mobile phone device is connected to the vehicular navigation device 15. If the mobile phone device (55) is connected, operation proceeds to step S58. If it is not connected, operation jumps to step S60. In step S58, the wireless LAN program 120 and the TCP/IP program 130, which act as the network driver, start-up. In step S59, the news is received from the application server 52. In step S60, the application programs 150, 151 and the other device drivers 140 start-up. Then, in step S61, it is determined whether the vehicular navigation device 15 has completed start-up.

If start-up is completed, operation proceeds to step S62. If start-up is not completed, the operation returns to step S61. In step S62, it is determined whether the mobile phone device (55) is connected to the vehicular navigation device 15. If the mobile phone device (55) is connected, operation proceeds to step S63. If the mobile phone device (55) is not connected, the processing is terminated. In step S63, the news is displayed or voice output.

In this manner, according to this exemplary embodiment, for example, the removable wireless device 55, which is, for example, a cellular terminal, a mobile phone device, a PHS phone device, is capable of being connected to the network 51 so as to allow communication. Further, this removable wireless device 55 is connected to the vehicular navigation device 15. As a result, regardless of the location of the vehicle, it is possible to download data when the vehicular navigation device 15 starts up.

While this invention has been described in conjunction with the exemplary embodiments outlined above, various alternatives, modifications, variations, and/or improvements may be possible. Accordingly, the exemplary embodiments of the invention, as set forth above, are intended to be illustrative. Various changes may be made without departing from the spirit and scope of the invention.

What is claimed is:

1. A method for communicating a navigation device with a server, comprising:
instructing, prior to initiating start-up of a navigation device, a communication portion to communicate with a server;
starting-up the communication portion, the communication portion connected to the navigation device;
communicating with the server using the communication portion; and
starting-up, after the communication portion has started-up, portions of navigation device unnecessary for communication.

2. The method of claim 1, wherein starting-up the communication portion comprises starting-starting up a network driver.

3. The method of claim 2, wherein starting-up the network driver comprises starting up a wireless LAN program.

4. The method of claim 2, wherein starting-up the network driver comprises starting up a TCP/IP program.

5. The method of claim 1, wherein starting-up portions of the navigation device unnecessary for communication comprises starting-up drivers and programs unnecessary for communication.

6. The method of claim 1, wherein starting-up the communication portion comprises initiating starting-up the navigation device.

7. A navigation device, comprising:
a communication portion that is configured to communicate with a server that distributes data; and
a data storage portion that stores the data that is distributed from the server;
wherein, when start-up of the navigation device is initiated, communication with the server is executed and the distributed data is downloaded prior to completion of start-up.

8. The navigation device of claim 7, further comprising a controller that:
initiates start up of the navigation device;
starts-up the communication portion;
instructs the communication portion to communicate with the server, prior to completion of start-up of the navigation device.

9. The navigation device of claim 7, further comprising:
at least one of a display portion and a voice output portion, wherein after start-up of the navigation device is completed, data stored in the data storage portion is at least one of displayed on the display portion and voice output from the voice output portion.

10. The navigation device of claim 7, wherein when an operating system starts up following initiation of start-up of the navigation device, a network driver starts up and the distributed data is downloaded, and then start-up of a device driver other than the network driver and an application program is executed.

11. The navigation device of claim 7, wherein data that is pre-set is downloaded from the server.

12. The navigation device of claim 7, wherein the communication portion is a wireless local area network device.

13. The navigation device of claim 7, wherein the communication portion is a removable cellular terminal.

14. The navigation device of claim 7, wherein the communication portion communicates directly with the server.

15. The navigation device of claim 7, wherein the communication portion communicates with an information terminal, the information terminal connected to the server through a network.

16. A navigation device, comprising:
means for instructing, prior to initiating start-up of a navigation device, a communication portion to communicate with a server;
means for starting-up the communication portion, the communication portion connected to the navigation device;
means for communicating with the server using the communication portion; and
means for starting-up, after the communication portion has started-up, portions of navigation device unnecessary for communication.

17. A storage medium storing a set of program instructions executable on a data processing device and usable for communicating a navigation device with a server, the set of program instructions comprising:
instructions for instructing, prior to initiating start-up of a navigation device, a communication portion to communicate with a server;
instructions for starting-up the communication portion, the communication portion connected to the navigation device;
instructions for communicating with the server using the communication portion; and
instructions for starting-up, after the communication portion has started-up, portions of navigation device unnecessary for communication.
